(19) United States
(12) Patent Application Publication
(10) Pub. No.: US 2017/0217008 A1
(43) Pub. Date: Aug. 3, 2017

(54) Component Frame Retainer

(71) Applicant: Willis Gerald Major, Rochester, NY (US)

(72) Inventor: Willis Gerald Major, Rochester, NY (US)

(21) Appl. No.: 15/484,315

(22) Filed: Apr. 11, 2017

Related U.S. Application Data
(63) Continuation-in-part of application No. 14/702,678, filed on May 2, 2015.

(51) Int. Cl. B25G 3/28; B05C 17/02; A47L 13/38; A46B 5/00; A47L 13/16

(52) U.S. Cl. CPC B25G 3/28; A46B 5/0095; A47L 13/16; A47L 13/38; B05C 17/0205; B05C 17/0235; A46B 2200/202

(57) ABSTRACT

I claim an applicator component retainer for quickly detaching and attaching disposable components comprising of paint brush heads, paint roller covers, dusting feathers, dusting cloths, cleaning cloths, chemical wipes and sandpaper onto a hand tool applicator shaft, said applicator component retainer comprises:

an elongated hollow member,

a slot,

and at least one recessed member,

whereby said slot is positioned along the entire length of said elongated hollow member and whereby said slot creates an opening all the way from the outside to the inside of said elongated hollow member, and whereby recessed member extends from the elongated hollow member and whereby said recessed member is recessed away from the top of the slot forming material at a smaller height below the slot.

### CROSS-REFERENCE TO RELATED APPLICATIONS

I claim the benefits of the Non Provisional U.S. application Ser. No. 14/702,678 (submitted May 2, 2015), in this Continuation in Part Application.

### BACKGROUND

### Field of Invention

This invention relates to how components comprising of mini roller covers, brushes, cloths, feathers, wipes, sanding material and dusting material components are attached to a frame and how the frame uses a built in retainer that is attachable and detachable to hand tool applicator shafts. This invention is called a component frame retainer because said components above are attached to the frame or recessed members of my invention and then a retainer or elongated hollow member with a slot which is built into my invention is used to attach the frame on the shaft of a hand tool applicator. This continuation in part application has all of the benefits of U.S. application Ser. No. 14/702,678 in that a paint brush head and paint roller cover component can both be attached to the frame in each patent application and has a retainer with a tube and slot in each application, but in this continuation in part application, improvements to the frame and the attached retainer in U.S. application Ser. No. 14/702,678 are made to better allow mini roller covers, brushes, cloths, feathers, wipes, sanding material and dusting material components to attach to an improved component frame retainer. The component frame retainer has an improved retaining method to attach the component frame to a hand tool applicator shaft by way of a coupling retainer method with the retainer having a non-circular inner diameter cross-sectional shape to match the cross section of a hand tool shaft outer diameter shape with a mating non-circular shape to prevent rotation and the retainer having a slot running along its length from the outer diameter to the inner diameter of the retainer with an undercut recessed member on both sides and positioned below the slot and the recessed members extending out from the side of the retainer and acting as a frame to bond to components comprising of mini roller covers, brushes, cloths, feathers, wipes, sanding material and dusting components. There is also additional larger diameter tubes or attachment tubes connected to the undercut recessed member and multiple retainers and recessed undercut members that can be daisy chained with the larger diameter tubes to make a one piece component frame retainer that provides for a stronger retention force around the hand tool applicator shaft and helps to maintain a more balance and parallel form with respect to the hand tool applicator shaft and the larger diameter tubes are typically larger in diameter than the retainer and undercut recessed member allowing a roller cover inner diameter to attach to the Larger diameter tube's outer diameter without touching the retainer or recessed member.

### BACKGROUND

### Description of Prior Art

Thomas U.S. Pat. No. 4,872,236, Biscoff U.S. Pat. No. 2,959,800, futo U.S. Pat. No. 7,523,518 b2, nagai us 2002/0042969, aL-samman U.S. Pat. No. 4,402,102, sauer us 2005/0278885, hirzel U.S. Pat. No. 5,176,754 and other patents have paint rollers and paint brushes or a combination of the two in various materials such as foam or nylon. These are mainly complete painting applicators. My invention differs from those above in that first, I don't have a complete paining applicator with a handle or shaft that I am claiming I am claiming only a quick attaching/detaching component of an applicator which is the disposable part of the applicator instead of the complete applicator, secondly my invention is disposable and attachable and detachable to the actual hand tool applicator shaft or paint applicator frame shaft, and thirdly I can attach multiple differing components such as mini roller covers, brushes, cloths, feathers, wipes, sanding and dusting components to my component frame. Then there are those with patented paint roller components that are disposable and they are attached and detached from a paint roller frame shaft. Some of these paint roller covers are attached using an internal circular C-shaped plastic tube that grabs around a painting frame shaft while the C-shaped plastic tube is not attached to the mini paint roller cover core but is freely trapped between two tubular cores that are internally attached to the mini roller cover while the circular C-shaped plastic tube is loosely held inside without being attached to anything but it is only trapped. This current style of attaching mini paint roller covers to paint roller frame shafts allow the mini paint roller cover to easily attach and detach from the shaft while allowing the paint roller cover to freely rotate around the shaft of the painting frame applicator. With my invention there are many differences from these current mini roller covers, first I have many types of disposable components that are allowed to be attached to my frame such as mini roller covers, brushes, cloths, feathers, wipes and dusting components, secondly there are combinations of more than one component that are allowed to be attached to my frame at the same time, thirdly my frame and retainer is coupled to the hand tool applicator shaft through mainly a non-circular mating pair to prevent rotation of the attached components where in one form of my invention my roller cover is made not to rotate to allow the cover to dust or sand when dusting and sanding components are attached whereas in current patents the mini roller is always designed to rotate but since I am claiming a frame retainer without components I allow components to attach to my frame retainer in such a way to prevent them from rotating unlike other roller covers. I also have multiple interrupted slotted elongated hollow members and recessed members in series to provide for a stronger gripping force on the shaft that can more than double the current force from C-shaped trapped slotted tubes from existing patents and my inventions allows for even positioning of my frame retainer and components that are attached to it to be more parallel to the hand tool applicator shaft since I have multiple retainers to grip the shaft in more than one place and they are allowed to be positioned at the beginning and at the end of the shaft to make attaching components to my frame retainer stay parallel to the shaft during use unlike other inventions which have only one slotted C-shaped tube trapped in the center of the mini roller or at the end of the mini roller which causes the mini roller to tilt during use, a mini paint roller cover is attached to my frame retainer instead of slipped over the shaft of the applicator hand tool painting frame and the mini paint roller cover is allowed to be attached in a non-rotating manner or rotating manner around my frame retainer unlike over mini roller covers or the mini paint roller cover being stationary around my frame is important in application where my frame retainer is being used with a drill or applicators that have the shaft rotating instead of the attaching component rotating and where these applications need a non-rotating component where unlike other patents my invention allows for a non-rotating component due only my invention having a non-circular mating inner diameter polygon shape connecting with the shaft and the current mini roller covers made to automatically spin around all shafts instead of being made to have a frame that is stationary around the shaft, my invention is not limited to circular painting frame shafts and can be installed on various hand tool applicators shafts in many designs, angles and configurations because the shape of the inner diameter of my retainer is made to match and couple to the non-circular shape of the outer diameter shape of the hand tool applicator shaft unlike other patents, my retainer has one or more undercut recessed members extending from the sides of the slotted elongated tube and the recessed members are purposely made lower than the slot to allow the portion of the slot where the recessed member is not present to open easier but also the recessed members on the side act to help the slot return to shape and have a stronger force against the shaft due to having more strength by way of the solid recessed member being attached to the slotted tube instead of detached as the case is with the freely floating C-shaped slotted tube trap between two attached tubes in the current day mini paint roller covers where there is no recessed member attached to either side of the C-shaped slotted tube, also current mini roller covers or there internal C-shaped slotted tubes cannot be connected to brushes, cloths, feathers, wipes, sanding and dusting components because their slotted C-shaped plastic tube has no recessed members attached to the sides of the C-shaped slotted tube like in my invention which makes this attachment possible, the C-shaped slotted tube in current mini rollers have a circular cross-section and this shape provides only a limited ability to prevent rotating of an attaching roller and also C-shaped slotted tubes that are designed to be freely trapped as in the current mini rollers patents must stay freely trap to allow the mini roller cover to perform its purpose of rotating whereas in my invention the elongated slotted member is not freely trapped but attached to recessed members to make it stronger and to prevent rotation of my frame retainer but my invention also provides a body for a component to rotate around, no one skilled in this art would even think about modifying current patented mini roller with C-shaped slotted tubes to stop being freely trapped to being attached to recessed members because the main purpose of the mini paint roller cover to rotate around an applicator hand tool shaft would be prevented but with a novel frame retainer such as in my invention my framer retainer can attach to a hand tool shaft and not rotate but thee mini roller cover component is allowed to rotate around my frame retainer. The person skilled in the art would not want to prevent the mini paint roller cover from rotating which is the prime job of the mini roller cover and no one skilled in the art would add other non-rotating components such as a brush, cloth, wipe, dusting or sanding material to the mini roller cover and expect the other components not to rotate because the purpose of the roller is to rotate, but my invention is unique in that it has a component frame retainer where component can attached and rotate around my invention or stay stationary around my invention. meeting all prime modes of operation instead of the current mode of operation in patents to only rotate. There is no current means of preventing the current mini rollers from rotating when attached to an applicator frame shaft whereas in my invention of having the recessed members extending from the slotted elongated hollow member and having the inner diameter being non-circular on my frame retainer allows my invention to prevent all rotation so that the components can stay stationary and wipe, brush or sand something more adequately, my invention can also use old standard roller covers that only have the internal tubular core and thus a new way of attaching standard rollers covers to a shaft of a hand tool applicator can be used with my invention where only the old standard roller cover has to be disposed of and my frame retainer invention can be reused with another old standard roller and now some of the millions of old rollers that have become obsolete can now be reused with my invention, my invention can be used with power tools such as gun drills that have a non-circular shaft or circular shaft, can be used on the standard paint applicator circular shape shafts as well as on non-circular shaped shafts wherever as current patents do not have the ability to be used in all of the above applications, my invention is made in a way that allows the same hand tool applicator shaft to connect many different types of disposable components such as mini roller covers, brushes, cloths, feathers, wipes, sandpaper and dusting cloths to the shaft by way of using my retainer and frame invention where as other patents in this field cannot achieve this function with their features or combined features, the uniqueness of my slotted elongated hollow member with recessed members that extend from both sides of the slotted elongated hollow member and are position below the top of the slot is the main improvement in this continuation in part application. I also added a 90 degree disk and a 180 degree panel for attaching a wedged shape foam material to the left of the slotted elongated hollow member and a 90 degree disk to the right with a through hole for accepting a hand tool shaft and to act as a paint roller stop and to have two legs or an attachment tube extend to the right for accepting a paint roller cover to rotate around and two wedged shaped retainers at the end of the two legs or attachment tube to retain the paint roller cover. The form of my invention allows a stationary paint brush head and a rotating paint roller cover combination disposable component that can freely attached and detach from a hand tool applicator shaft where the hand tool applicator shaft is either circular or preferably noncircular for better coupling securement and this is unlike other patents. My frame and retainer is typically 180 degrees in shape and typically made from plastic in a plastic injection molding machine process, my 90 degree disks or 180 degree panels are circular or either polygon shaped and are typically 1 to 15 millimeters in thickness, typically 1 to 75 millimeters in width and length, may have a through hole or are solid, the 180 degree panel may be flexible to allow a paint brush head to bend in order to perform the act of brushing on paint or some other chemical, the disk may be rigid to prevent movements of an attached component if flexibility is unwanted. Material type and thickness will control this flexibility option, while the slotted tube and recessed member typically have an outer diameter from 1 millimeter to 25 millimeters, have a length from 1 millimeter to 300 millimeters, there is typically 1 slotted elongated hollow member and a recessed member on both sides of the elongated hollow member but there can be configuration where there are multiple slotted elongated hollow members daisy-chained to multiple recessed members or multiple slotted elongated hollow members with recessed members on both sides daisy chained to multiple attachment tubes with larger outer diameters to provide more griping strength of the frame retainer around a hand tool applicator shaft to allow the frame retainer to stay on tighter which is an improvement over the existing slotted C-shaped freely trapped tubes that are currently used in mini paint rollers, also instead of a C-shaped tube with a slot I can accomplish the function of a stronger grip and non-rotating frame component with my invention in the form of a non-circular internal diameter tube by using an internal diameter with a polygon shaped length with a through slot along the length and at least one recessed member extending from the end that is recessed below the top of the slot such as a triangular conduit with a slot with one of the points being the top and two recessed members extending from each side and being below the top of the slot and with these recessed members attached to other material will provide a strong gripping force of the slot to grip around a hand tool shaft. Another difference in my invention from other patents is that my invention is allowed to be in the form in which a polygon or circular shaped tube is slotted on its length all the way through having a smaller outer diameter to grip around a hand tool mating polygon or circular shaft while there is a larger circular shaped tube diameter that circumscribes the smaller polygon shaped tube outer diameter extending from at least one side of the polygon shaped slotted tube recessed member such that the smaller diameter polygon slotted tube grips around a hand tool applicator shaft while not making contact with the attaching components such as a mini paint roller cover inner diameter while it is rotating around the large circular shaped tube diameter, this allows my invention to be in the form of a one piece molded plastic tube with a larger attaching tube diameter for the mini roller cover to rotate around and smaller slotted tube retaining diameters to grip the shaft of a hand tool applicator in one or multiple places for a stronger grip and more balanced grip to keep the mini roller internal core parallel to the hand tool shaft. These are the above reasons way my invention is unique, novel and nonobvious to other patents.

### SUMMARY

In accordance with the present invention, the “Component Frame Retainer” mainly comprises an elongated hollow member with a slot starting from beyond the outer surface running through to below the inner surface of the elongated hollow member and the slot is at the top of the elongated hollow member and runs along the entire length of the elongated hollow member and at least one recessed member that is recessed below the top of the slot and extends from the side of the elongated hollow member and is used to attach disposable components comprising of roller covers, brushes, cloths, wipes, feathers, and sand paper. There is a polygon shaped cross-section inner diameter of the elongated hollow member that is made for surrounding and strongly gripping the outer diameter of hand tool applicator shafts having a mating polygon shape on its outer diameter and the “Component Frame Retainer” is easily attachable and detachable from hand tool shafts by inserting or removing hand tool shaft outer diameters into and out of the inner diameter of the elongated hollow member. My “Component Frame Retainer” and the attaching components on my “Component Frame Retainer” are all disposable or the components attached to my “Component Frame Retainer” are allowed to be the disposable while my “Component Frame Retainer” is reusable and attaching components are non-rotating as well as rotating while attached. The ability to use this “Component Frame Retainer” for attaching a combination of components of both a paint brush head and a mini roller cover to a hand tool applicator shaft is common with my previous application U.S. application Ser. No. 14/702,678 and the ability to use an elongated hollow member tube with a slot to directly attach components and keep the component frame stationary while attached to a hand tool applicator shaft and have a non-circular cross-section inner diameter that mates to a hand tool applicator shaft are all things common between this continuation in part application and my previous application U.S. application Ser. No. 14/702,678 .

### OBJECTS AND ADVANTAGES

Accordingly, several objects and advantages of the “Component Frame Retainer” described in my above patent are:

(a) to provide a frame and retaining feature for attaching a variety of components and combination of components for painting, staining, dusting, polishing, striping, sanding, cleaning, wiping off or applying chemicals (liquid and powder) to objects around the same hand tool shaft by using an improve component frame retainer;

(b) to provide a stronger, more balanced and stationary way of attaching and retaining components for painting, staining, dusting, polishing, striping, sanding, cleaning, wiping off or applying chemicals (liquid and powder) to objects around a hand tool shaft with an improve component frame retainer;

(c) to provide a simpler way of attaching and retaining a combination of different components for painting, staining, dusting, polishing, striping, sanding, cleaning, wiping off or applying chemicals (liquid and powder) to objects with an improve component frame retainer;

Further objectives and advantages of my invention will become apparent from a consideration of the drawings and ensuing description.

### DRAWING FIGURES

In accordance with the present invention the “Component Frame Retainer” mainly comprises an elongated hollow member, a slot at the top of the elongated hollow member, and a recessed member below the slot and extending from the side of thee elongated hollow member.

FIG. 1) shows the “Component Frame Retainer” with an elongated hollow member with a recessed member on the left and right side of the elongated hollow member along with a slot and inner diameter as a D-shape.

FIG. 2) shows the “Component Frame Retainer” with different elongated hollow member inner diameter shapes including D-shaped, circular shaped, triangular shaped, and polygon shaped with a recessed member on the left and right side of each elongated hollow member along with a slot.

FIG. 3A) shows the 180 degree solid panel with and without a through hole and the 90 degree solid disk for attaching to the left side of the recessed member that is on the left side of the elongated hollow member of the “Component Frame Retainer”.

FIG. 3B) shows the 90 degree solid disk with a through hole attached to two legs with leg retainers at the end of the legs with two leg rings joining the two legs in two positions along the length of the two legs.

FIG. 4) shows the “component Frame Retainer” with the 180 degree hollow panel, 90 degree solid disk, D shaped elongated hollow member with two recessed members and the 90 degree hollow disk with two legs attached in the top view while the bottom view shows a 180 degree solid panel, 90 degree solid disk, D-shaped elongated hollow member with recessed members, a 90 degree solid disk connected to an attachment tube and attachment retainers at the end of the attachment tube.

FIG. 5) shows the “component Frame Retainer” with the 90 degree solid disk, D shaped elongated hollow member with two recessed members, with the 90 degree hollow disk, two legs in the top view and in the bottom view there is an attachment tube and attachment tube retainers instead of two legs.

FIG. 6) shows the “component Frame Retainer” with the 180 degree hollow disk, 90 degree solid disk, D shaped elongated hollow member with two recessed members, with the 90 degree hollow disk, two legs and the leg retainers and a wedged shaped foam brush material as well as a foam mini paint roller cover. In the left figure the wedged shape foam brush material and foam mini roller cover are not attached to the “Component Frame Retainer” and in the right figure the wedged shape foam brush material surrounds the 180 degree hollow disk and is glued in place while the foam mini roller cover slips around the two legs and is retained by the leg retainers.

FIG. 7) shows the “component Frame Retainer” with the 180 degree hollow disk, 90 degree solid disk, D shaped elongated hollow member with two recessed members, with the 90 degree hollow disk, two legs and the legs retainers and a wedged shaped foam brush material, cloth material, feather material, dusting material, chemical wipe material or sanding material component. In the left figure the wedged shape foam brush material, cloth material, feather material, dusting material, chemical wipe material or sanding material component is not attached to the “Component Frame Retainer” and in the right figure the wedged shape foam brush material, cloth material, feather material, dusting material, chemical wipe material or sanding material component surrounds the 180 degree hollow disk and is glued in place.

FIG. 8) shows the “component Frame Retainer” with the 90 degree solid disk, D shaped elongated hollow member with two recessed members, with two larger diameter attachment tubes on each side of the elongated hollow member with the right larger diameter tube having two legs attached and two leg retainers in the top view, in the middle view there is a 90 degree solid disk and to the right an elongated hollow member with two recessed members and only one larger diameter attachment tube to the right. In the bottom view there are multiple elongated hollow members and larger diameter attachment tube combinations daisy chained together to form a one piece “Component Frame Retainer”.

FIG. 9) shows the “component Frame Retainer” with the D-shaped elongated hollow member with the larger diameter attachment tube and a disposable mini paint roller cover, sanding cover, chemical applying cover, foam cover, dusting cover or cloth cover material component surrounding the outer diameter of the two large diameter attachment tubes with the top figure showing the larger diameter attachment tubes and the bottom view showing a side view of the elongated hollow member and larger diameter attachment tube with the disposable mini paint roller cover, sanding cover, chemical applying cover, foam cover, dusting cover or cloth cover material component.

### REFERENCE NUMERALS IN DRAWINGS

010 component frame retainer

020 elongated hollow member

021 left side of elongated hollow member

022 right side of elongated hollow member

023 top side of elongated hollow member

024 bottom side of elongated hollow member

030 elongated hollow member slot

040 left recessed member

041 left side of left recessed member

042 right side of left recessed member

050 right recessed member

051 left side of right recessed member

052 right side of right recessed member

060 component frame retainer with D-shaped elongated inner diameter

070 component frame retainer with circular shaped elongated inner diameter

080 component frame retainer with triangular shaped elongated inner diameter

090 component frame retainer with polygon shaped elongated inner diameter

095 component frame retainer for roller covers

100 D-shaped elongated inner diameter

110 circular shaped elongated inner diameter

120 triangular shaped elongated inner diameter

130 polygon shaped elongated inner diameter

140 180 degree solid panel

141 left side of 180 degree solid panel

142 right side of 180 degree solid panel

150 180 degree hollow panel

151 left side of 180 degree hollow panel

152 right side of 180 degree hollow panel

153 180 degree hollow panel hole

160 90 degree solid disk

161 left side of 90 degree solid disk

162 right side of 90 degree solid disk

170 90 degree hollow disk

171 left side of 90 degree hollow disk

172 right side of 90 degree hollow disk

173 90 degree hollow disk hole

180 parallel attachment legs

181 left end of parallel attachment legs

182 right end of parallel attachment legs

190 leg ring support

200 leg retainer

210 attachment tube

211 left side of attachment tube

212 right side of attachment tube

213 attachment tube retainer

220 disposable wedge shaped foam head, dusting head, chemical wipe head, sanding head, painting head, or staining head material

230 disposable mini paint roller cover, sanding cover, chemical applying cover, foam cover, dusting cover or cloth cover material.

240 mini head & mini cover attachable & detachable disposable component

250 paint brush head, dusting head, chemical wipe head, sanding head or staining head attachable and detachable disposable component

260 mini paint roller cover, sanding cover, chemical applying cover, foam cover, dusting cover or cloth cover attachable & detachable disposable component

280 open end inner diameter of the component frame retainer for inserting an applicator hand tool shaft into the open end inner diameter

### DESCRIPTION

First Preferred Component Frame Retainer

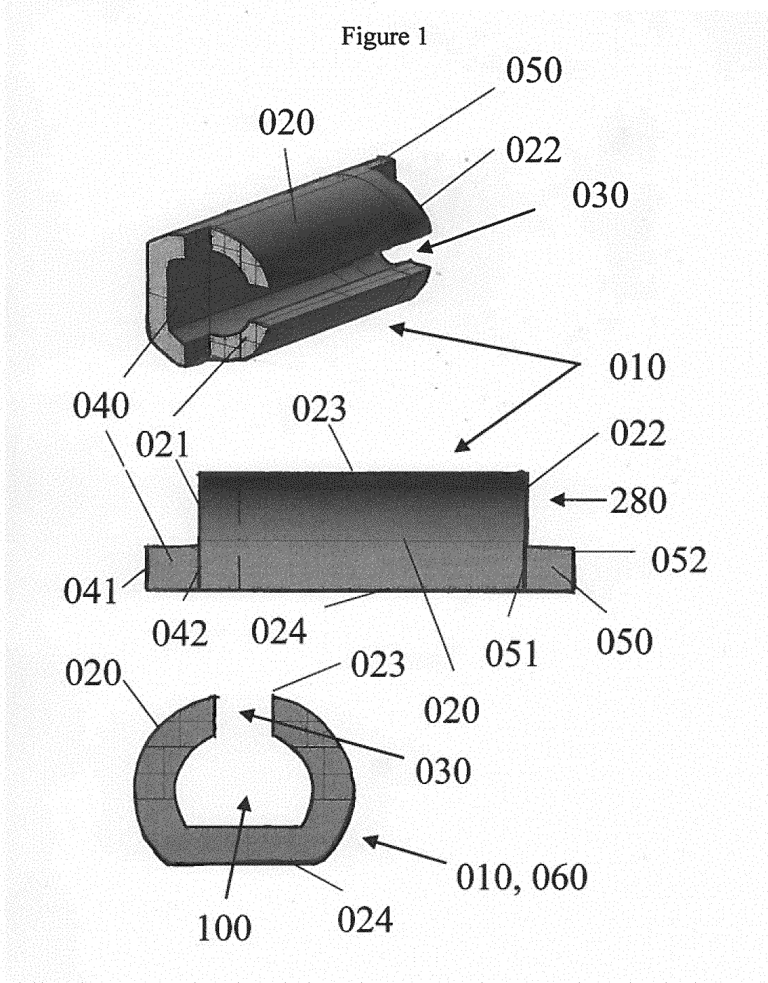

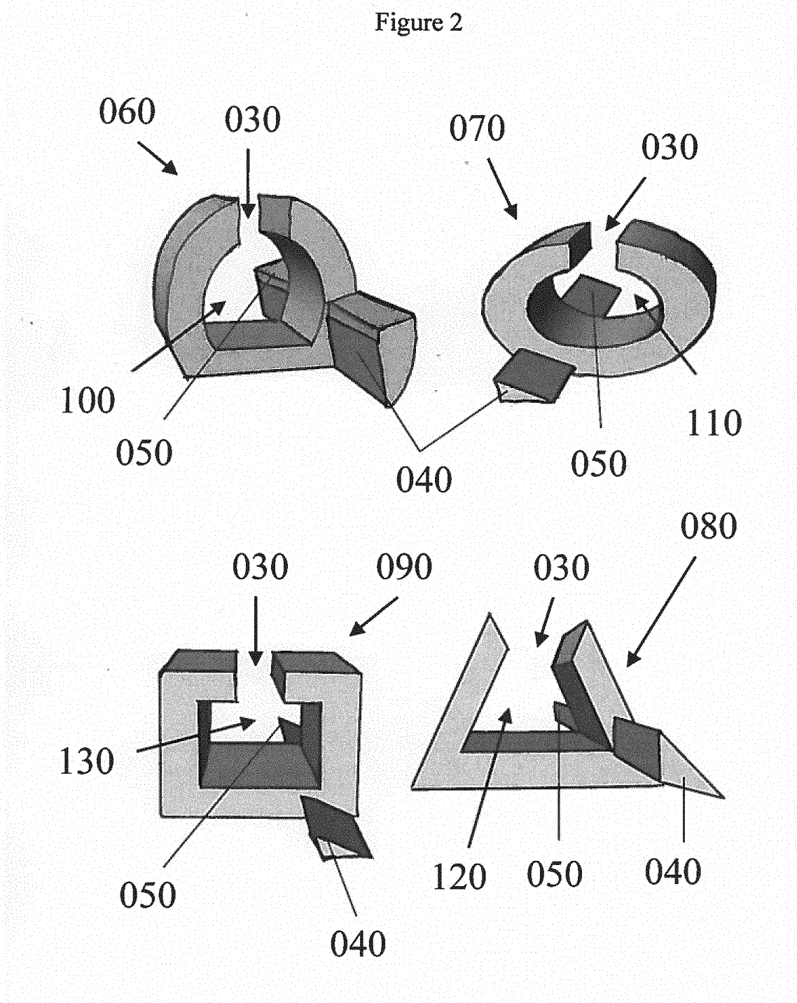

A first preferred embodiment of the “Component Frame Retainer 010” is illustrated in FIGS. 1 and 2. The “Component Frame Retainer 010” main parts generally comprises of an elongated hollow member 20, a D-shaped inner diameter 100 or circular shaped inner diameter 110, or polygon shaped inner diameter 130 or triangular shaped inner diameter 120 and a left side of elongated hollow member 021, a right side of elongated hollow member 022, a top of elongated hollow member 023, a bottom of elongated hollow member 024, an elongated hollow member slot 030 that runs along the length of the top of the elongated hollow member 023 from the left side of elongated hollow member 021 to the right side of elongated hollow member 022, a left recessed member 040 that is below the top of the slot 030 and is connected to the left side of elongated hollow member 021 and a right recessed member 050 that is below the top of the slot 030 and is connected to the right side of the elongated hollow member 022 and the slot 030 also runs from the top of elongated hollow member 023 to the inside of the D-shaped inner diameter 100 or circular shaped inner diameter 110, or polygon shaped inner diameter 130 or triangular shaped inner diameter 120 whereby one side of the inner diameter is an open end inner diameter of the component frame retainer for inserting an applicator hand tool shaft into the open end inner diameter 280. The “Component Frame Retainer” is allowed to be attached to a variety of disposable applicator components comprising a disposable wedge shaped foam head, dusting head, chemical wipe head, sanding head, painting head, or staining head material 220, or a disposable mini paint roller cover, sanding cover, chemical applying cover, foam cover, dusting cover or cloth cover material 230, by way of connecting the disposable applicator component to the left recessed member 040 and/or the right recessed member 050 using adhesive or a variety of mechanical attachment means comprising of bolting, crimping, press-fit, rivet, snap-fit, coupling and clamping.

Second Preferred Component Frame Retainer

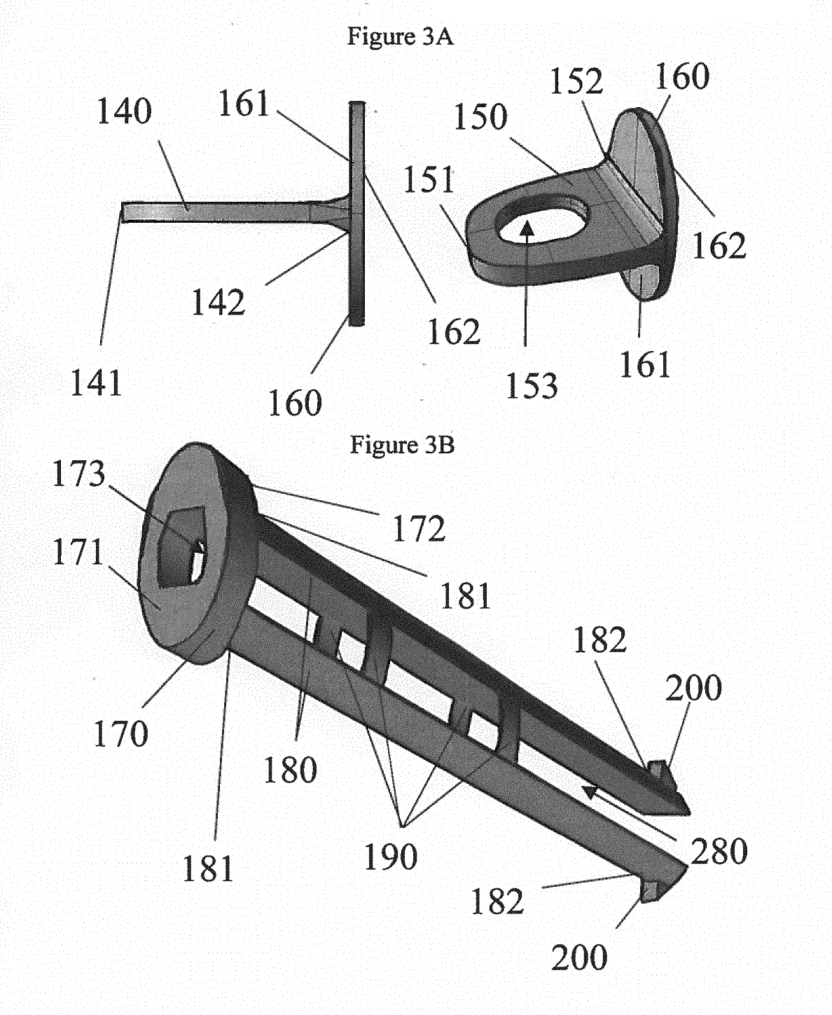

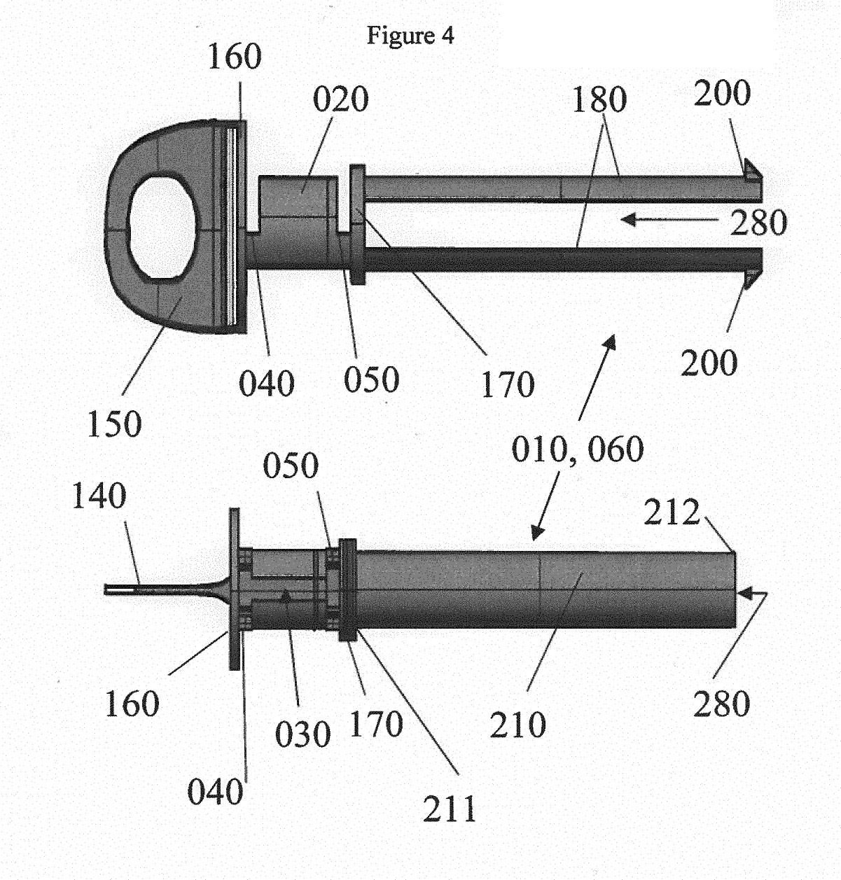

A second preferred embodiment of the “Component Frame Retainer” is illustrated in FIGS. 3A, 3B, and 4. The “Component Frame Retainer 010” main parts generally comprises of an elongated hollow member 20, a D-shaped inner diameter 100 or circular shaped inner diameter 110, or polygon shaped inner diameter 130 or triangular shaped inner diameter 120 and a left side of elongated hollow member 021, a right side of elongated hollow member 022, a top of elongated hollow member 023, a bottom of elongated hollow member 024, an elongated hollow member slot 030 that runs along the length of the top of the elongated hollow member 023 from the left side of elongated hollow member 021 to the right side of elongated hollow member 022, a left recessed member 040 that is below the top of the slot 030 and is connected to the left side of elongated hollow member 021 and a right recessed member 050 that is below the top of the slot 030 and is connected to the right side of the elongated hollow member 022 and the slot 030 also runs from the top of elongated hollow member to the inside of the D-shaped inner diameter 100 whereby one side of D-shaped inner diameter 100 is an open end inner diameter of the component frame retainer for inserting an applicator hand tool shaft into the open end inner diameter 280. The left recessed member 040 is connected to the right side of a 90 degree solid disk 160 and the left side of the 90 degree solid disk 160 is connected to an 180 degree solid panel 140 or an 180 degree hollow panel 150, the right recessed member 050 is connected to the left side of a 90 degree hollow disk 170 and the right side of the 90 degree hollow disk 170 is either connected to attachment legs 180 that have attachment leg rings 190 and attachment leg retainers 200 or the right side of the 90 degree hollow member 170 is connected to an attachment tube 210. The 180 degree solid panel 140 or an 180 degree hollow panel 150 is adhered to and surrounded by a disposable wedge shaped foam head, dusting head, chemical wipe head, sanding head, painting head, or staining head material 220 with the point of the wedge shaped foam material facing away from the 90 degree solid disk 160. The attachment legs 180 outer diameter are surrounded by a disposable mini paint roller cover, sanding cover, chemical applying cover, foam cover, dusting cover or cloth cover material 230 inner diameter and rotates freely around the attachment legs 180 and held locked on the attachment legs 180 by way of the attachment leg retainers 200 or the disposable mini paint roller cover, sanding cover, chemical applying cover, foam cover, dusting cover or cloth cover material 230 surrounds the attachment tube 210 and freely rotates around the attachment tube 210.

Third Preferred Component Frame Retainer

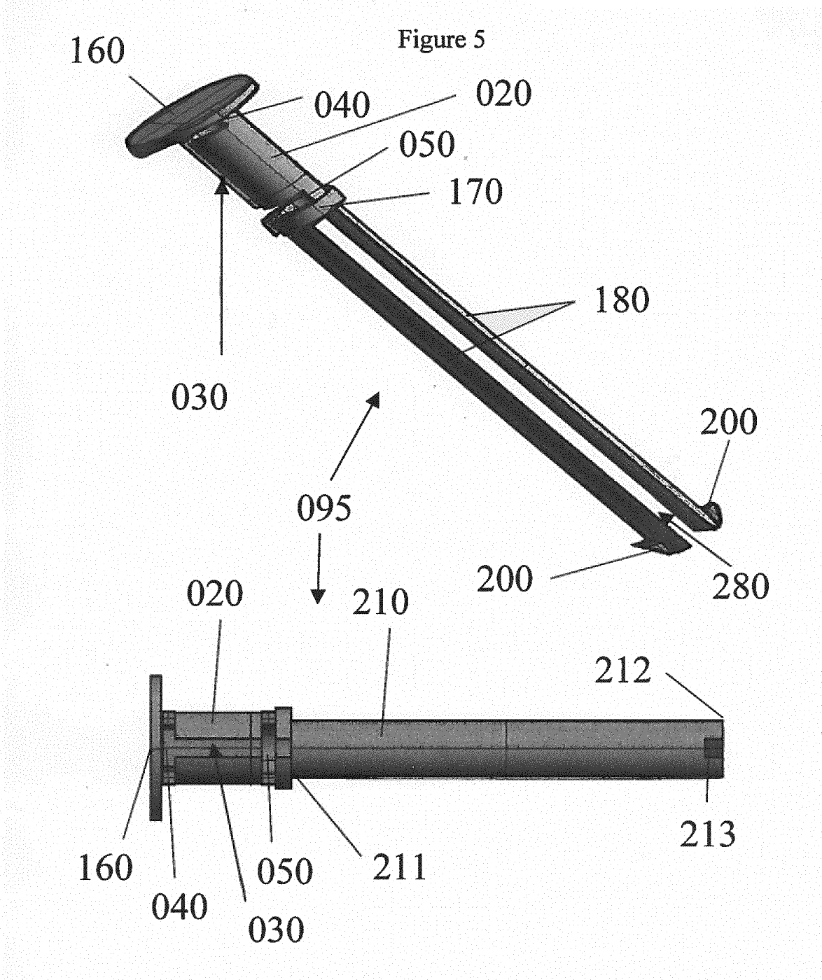

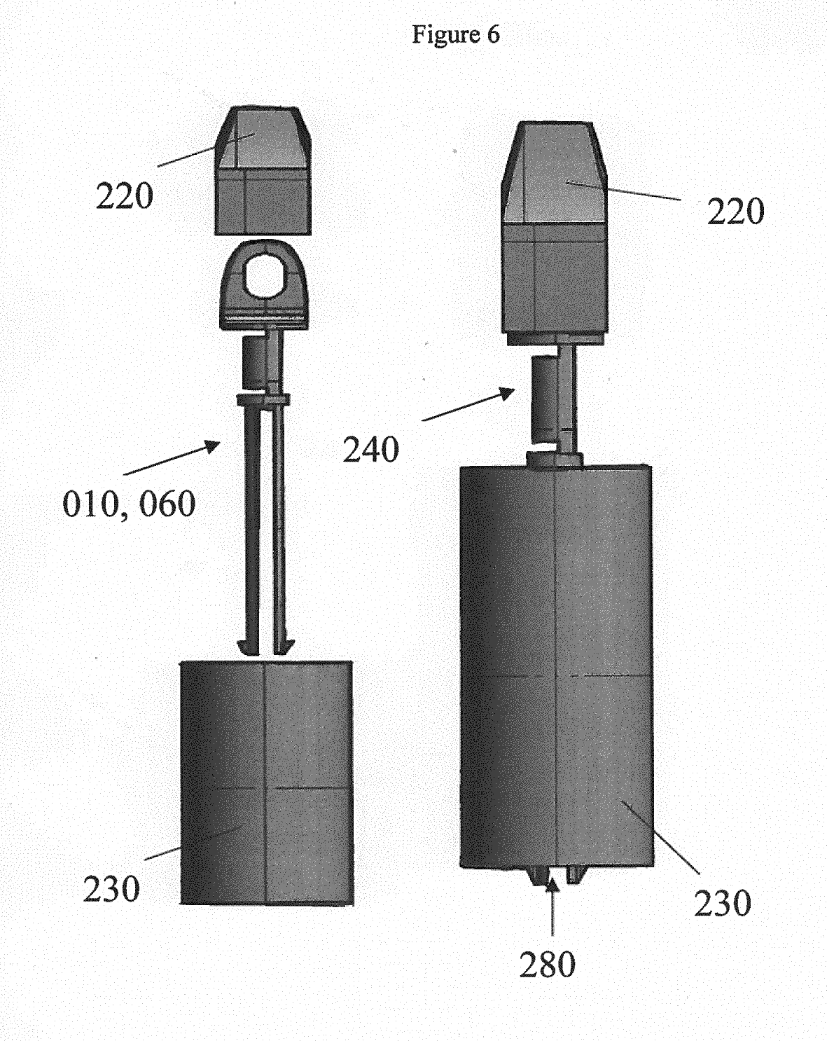

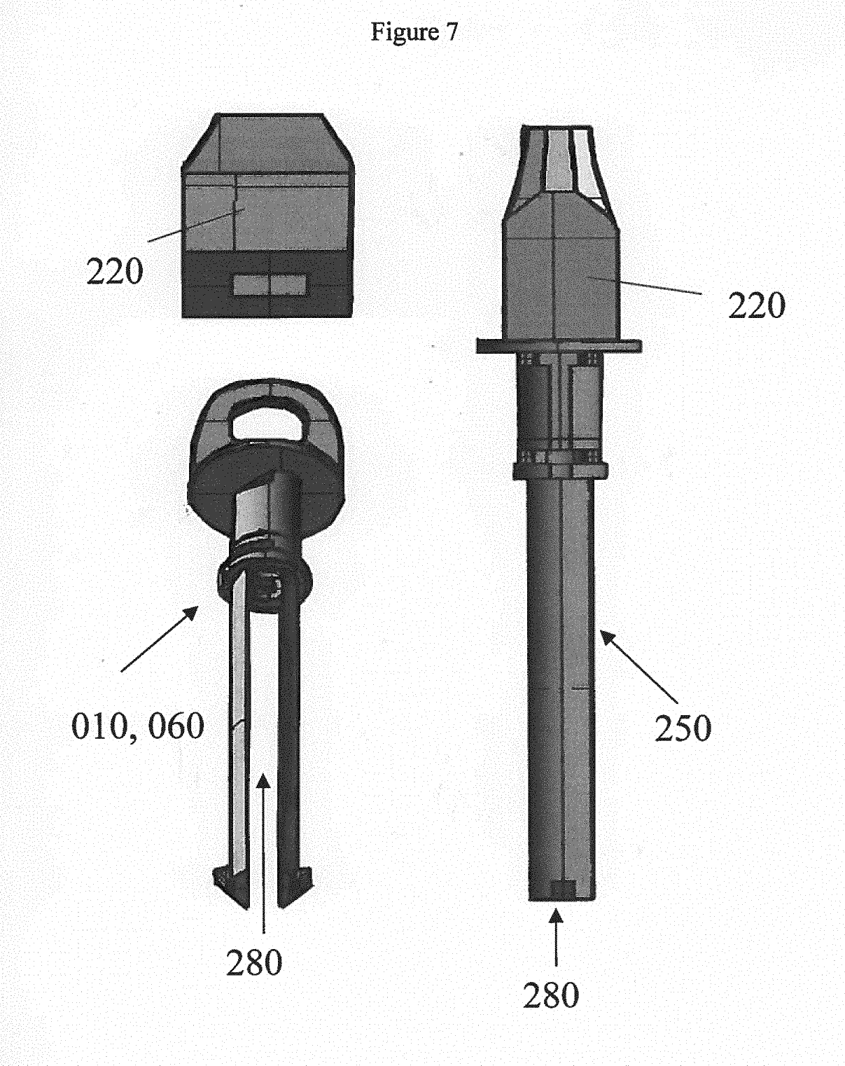

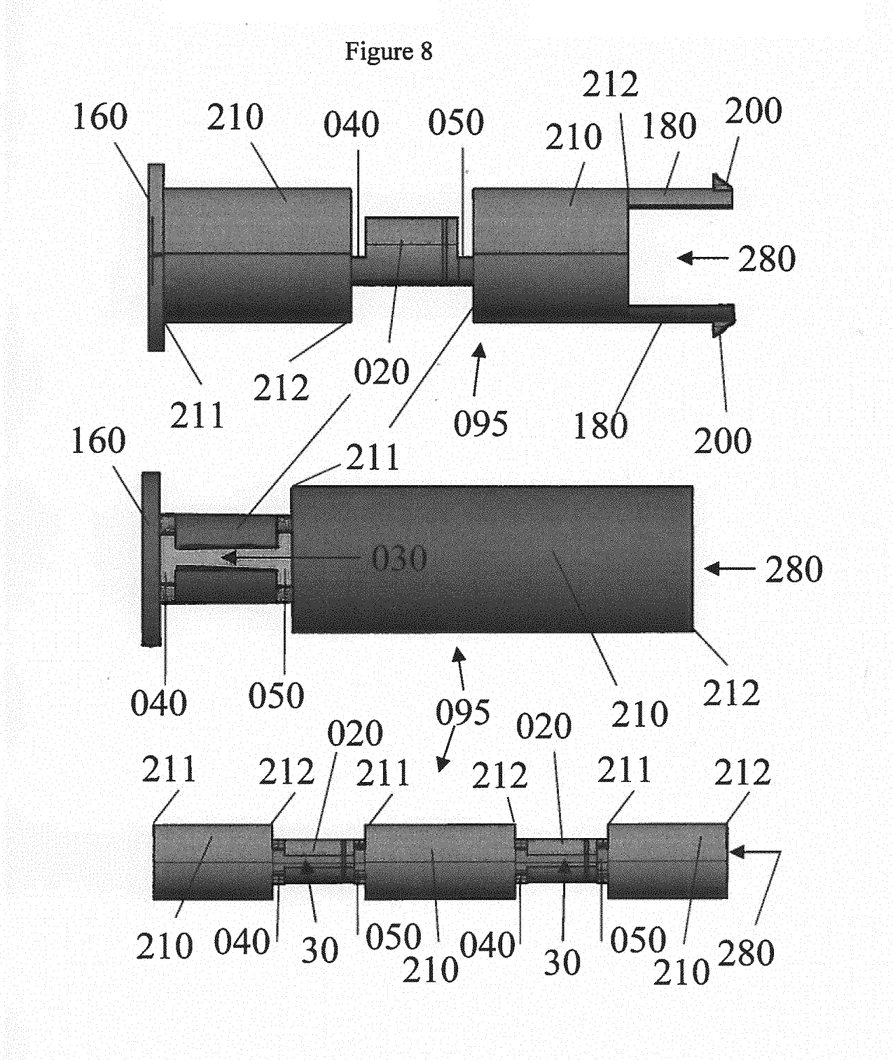

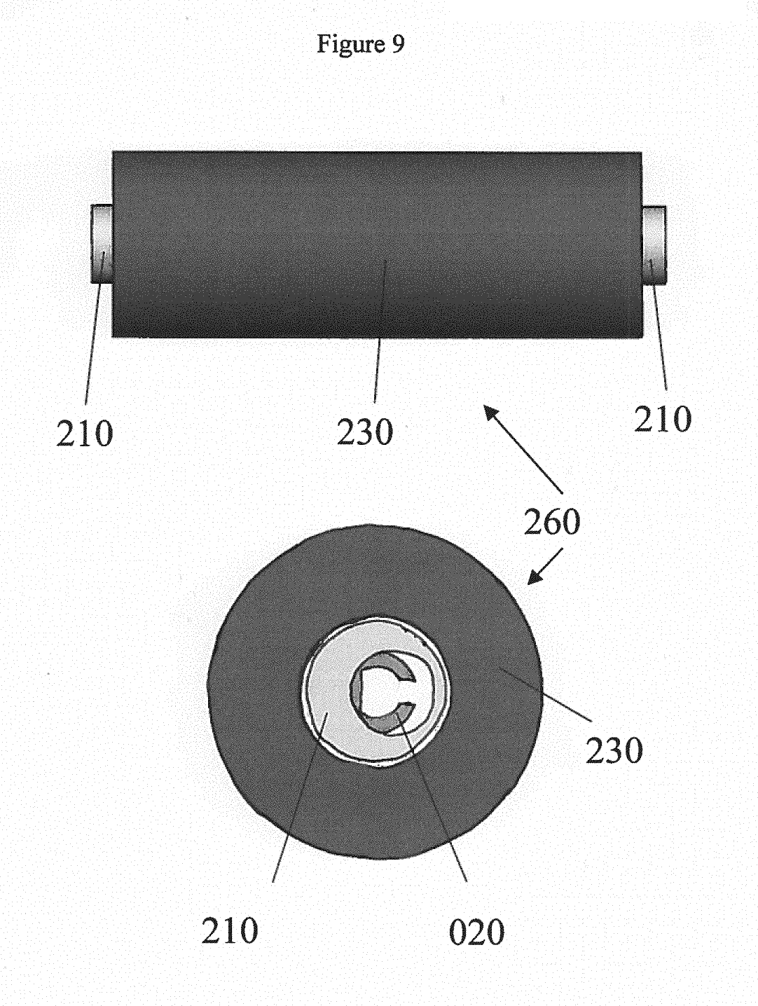

A third preferred embodiment of the “Component Frame Retainer” is illustrated in FIGS. 5 and 8. The “Component Frame Retainer 010” main parts generally comprises of an elongated hollow member 20, a D-shaped inner diameter 100 or circular shaped inner diameter 110, or polygon shaped inner diameter 130 or triangular shaped inner diameter 120 and a left side of elongated hollow member 021, a right side of elongated hollow member 022, a top of elongated hollow member 023, a bottom of elongated hollow member 024, an elongated hollow member slot 030 that runs along the length of the top of the elongated hollow member 023 from the left side of elongated hollow member 021 to the right side of elongated hollow member 022, a left recessed member 040 that is below the top of the slot 030 and is connected to the left side of elongated hollow member 021 and a right recessed member 050 that is below the top of the slot 030 and is connected to the right side of the elongated hollow member 022 and the slot 030 also runs from the top of elongated hollow member 020 to the inside of the D-shaped inner diameter 100 whereby one side of D-shaped inner diameter 100 is an open end inner diameter of the component frame retainer for inserting an applicator hand tool shaft into the open end inner diameter 280. In FIG. 5 the left recessed member 040 is connected to the right side of a 90 degree solid disk 160, the right recessed member 050 is connected to the left side of a 90 degree hollow disk 170 and the right side of the 90 degree hollow disk 170 is either connected to attachment legs 180 that have attachment leg rings 190 and attachment leg retainers 200 or the right side of the 90 degree hollow member 170 is connected to an attachment tube 210. In the FIG. 8, the left recessed member 040 is connected to the right side of an attachment tube 212 and the left side of the attachment tube 211 is attached to the 90 degree solid disk 160. The right recessed member 050 is attached to the left side of another attachment tube 211 and the right side of the attachment tube 212 is attached to the attachment legs 180 and at the end of the attachment legs are attachment retainers 200 in the top figure or attachment to another elongated member 020 and another attachment tube 210 in the bottom figure. In the middle figure the left side of the recessed member 040 is attached to a 90 degree solid disk 160 and the right recessed member is attached to an attachment tube 210.

First Preferred Component Frame Retainer Operation

The first step would be to determine what application the “Component Frame Retainer” is going to be used in. This would determine which disposable applicator component comprising of wedge shaped foam material, paint brush head, foam mini paint roller cover, feathers, dusting material, cloths, sanding material, and wipes would be attached to the “Component Frame Retainer”. If you were painting, staining, dusting, polishing, striping, cleaning, wiping off & applying chemicals (liquid and powder), drying, sanding, or scraping each of these different operations would require you to pick out a different disposable applicator component material to be attached to the “Component Frame Retainer” for that specific operation. Manufacturing would build the “Component Frame Retainer” with the specific disposable applicator components already permanently attached or there are non-permanent attachment mechanisms of the disposable applicator components that allow the operator to choose which disposable applicator components to attach to the “Component Frame Retainer” and then the operator can attach and detach the various combination of disposable applicator components they desire onto the “Component Frame Retainer” then the “Component Frame Retainer” will be ready for use. The “Component Frame Retainer” would need to be installed on the D-shaped shaft outer diameter of a hand tool applicator shaft by inserting the shaft outer diameter through the D-shaped inner diameter hole of the elongated hollow member of the “Component Frame Retainer” and the shaft would make the slot in the elongated hollow member expand in width growing the inner diameter D-shaped hole and making the D-shaped hole spring back and strongly grip around the D-shaped shaft outer diameter of the hand tool applicator and staying strongly coupled together by way of the combination of the mating D-shapes and the spring force of the elongated hollow member. Once the “Component Frame Retainer” is attached around the hand tool applicator shaft the hand tool can apply the disposable components that are attached to the “Component Frame Retainer” to the desired object to be painted, dusted, cleaned, sanded or chemicals wiped or stripped. When the operator is done the permanent combination of the disposable component and the “Component Frame Retainer” can all be disposed of and a new permanent combination can be used on the hand tool applicator. But if the non-permanent disposable components are used the operator can detach them from the “Component Frame Retainer” and then attach a new unused disposable non-permanent components for the next application.

Second Preferred Component Frame Retainer Operation

The first step would be during the manufacturing phase to build disposable applicator components already permanently attached or non-permanent disposable applicator components that are attachable and detachable on the “Component Frame Retainer”. A wedged shaped foam material is permanently glued, crimped, plastic welded, to the 180 degree hollow panel or 180 degree solid panel or the wedged shaped foam material is made to be mechanically attachable or detachable to the 180 degree solid panel or 180 degree hollow panel using a quick method such as being screwed on, snapped on, clipped on. The core inner diameter of a mini roller cover is slid around the two legs or the larger diameter tube of the “Component Frame Retainer” and held onto the legs or the larger diameter tube with the tube retainers or legs retainers. The ring helps to keep the legs parallel and apart so that the mini roller cover can have a shape to rotate around and when the legs are pushed together the mini roller cover is allowed to slide off of the legs and over the leg retainers due to them forming a smaller outer diameter than the inner diameter of the mini roller cover. The “Component Frame Retainer” would then be installed on the D-shaped shaft outer diameter of a hand tool applicator shaft by inserting the D-shaped shaft outer diameter between the two legs or inside of the lager diameter tube and through the D-shaped inner diameter hole of the elongated hollow member of the “Component Frame Retainer” as the shaft would make the slot in the elongated hollow member expand in width growing the D-shaped inner diameter hole and making the D-shaped inner diameter hole strongly grip around the D-shaped shaft outer diameter of the hand tool applicator shaft and staying strongly coupled together by way of the combination of the mating D-shapes and the spring force of the elongated hollow member. Once the “Component Frame Retainer” is attached around the hand tool applicator shaft the hand tool can apply the disposable components that are attached to the “Component Frame Retainer” to the desired object to be painted, dusted, cleaned, sanded, chemical wiped or stripped. When the operator is finish using the combination of the permanent disposable component and the “Component Frame Retainer”, they can all be disposed of and a new permanent combination can be used. But if the non-permanent components are used the operator can detached them from the “Component Frame Retainer” and then attached new unused disposable components to the “Component Frame Retainer” for the next application.

Third Preferred Component Frame Retainer Operation

The first step would be during the manufacturing phase to build disposable applicator components already permanently attached or non-permanent disposable applicator components that are attachable and detachable on the “Component Frame Retainer”. The inner diameter of a mini roller cover is slid around the two legs and/or the larger diameter tube of the “Component Frame Retainer” and held on to the legs and/or the larger diameter tube with the tube retainers or legs retainers. When the legs are pushed together the mini roller cover is allowed to slide off of the legs and over the leg retainers due to them forming a smaller outer diameter than the inner diameter of the mini roller cover. The “Component Frame Retainer” would then be installed on the D-shaped shaft outer diameter of a hand tool applicator shaft by inserting it's D-shaped shaft between the two legs or inside of the lager diameter tube and through the inner diameter D-shaped diameter hole of the elongated hollow member of the “Component Frame Retainer” as the shaft would make the slot in the elongated hollow member expand in width growing the inner diameter D-shaped hole and making the D-shaped hole strongly grip around the D-shaped shaft outer diameter of the hand tool applicator shaft and staying strongly coupled together by way of the combination of the mating D-shapes and the spring force of the elongated hollow member. Once the “Component Frame Retainer” is attached around the hand tool applicator shaft the hand tool can apply the disposable components attached to the “Component Frame Retainer” to the desired object to be painted, dusted, cleaned, sanded, chemicals wiped or stripped. When the operator is done the combination of the permanent disposable component and the “Component Frame Retainer” can all be disposed of and a new permanent combination can be used. But if the non-permanent components are used the operator can detached them from the “Component Frame Retainer” and then attached new unused disposable components to the “Component Frame Retainer” for the next application.

Conclusions, Ramifications, and Scope

Accordingly, the reader will see that the “Component Frame Retainer” of this invention has advantages in that

(d) it provides a variety of components for painting, staining, dusting, polishing, striping, sanding, cleaning, wiping off or applying chemicals (liquid and powder) to objects to be attached to the same hand tool shaft by using an improve component frame retainer;

(e) it provides a stronger way of attaching and retaining components for painting, staining, dusting, polishing, striping, sanding, cleaning, wiping off or applying chemicals (liquid and powder) to objects around a hand tool shaft with an improve component frame retainer;

(f) it provides a simpler way of attaching and retaining a combination of different components for painting, staining, dusting, polishing, striping, sanding, cleaning, wiping off or applying chemicals (liquid and powder) to objects with an improve component frame retainer;

Further objectives and advantages of my invention will become apparent from a consideration of the drawings and ensuing description. Although the description above contains much specificity, these should not be construed as limiting the scope of the invention but as merely providing illustrations of some of the presently preferred embodiments of the invention. Thus the scope of the invention should be determined by the appended claims and their legal equivalents, rather than just by the examples given.

### DEFINITIONS

Disk: A plate, board, panel, sheet, plank, slat, beam, plain, slab, block that is 0.1 to 0.5 inches thick, 0.1 to 3.0 inches wide, and 0.1 to 3.0 inches long that is thin, a wafer-thin, narrow, that is flat, level, even, plane, straight, 180 degrees or 90 degrees, and can be horizontal, vertical, perpendicular, upright, straight up, straight down made out of rigid plastic or flexible plastic depending on function. Can be circular or polygon shaped and can be solid or hollow with a through hole.

Slotted Tube: A pipe, cylinder, conduit, duct, or spout with a slot from the outside outer diameter cutting through all the way to the inside diameter of the part along the entire length of the part and having an inner diameter and outer diameter.

Slot: A hole, groove, opening, space, slit

Recessed member: sunken, lower, dipped, depressed or smaller diameter, or cut away diameter member

Elongated hollow member: extended, lengthened, or drawn-out member with the same inner and outer diameter throughout which is 180 degree angle, a tube, a pipe, a cylinder, a conduit, a duct, or spout with an outer diameter and inner diameter.

Legs: limbs, supports, shafts, rods, pegs, pins, or extended members with a D-shaped cross-section.

Leg retainer/tube retainer: wedged shaped plastic form, tab, stub, stump, bump, bead, lump, bulge, lip, protrusion, flange, overhang, projection, or extension prevent an object from moving or sliding off of another object.

I claim:

1. I claim an applicator component retainer for quickly detaching and attaching disposable components comprising of paint brush heads, paint roller covers, dusting feathers, dusting cloths, cleaning cloths, chemical wipes and sandpaper onto a hand tool applicator shaft, said applicator component retainer comprises:
an elongated hollow member,
a slot,
and at least one recessed member,
whereby said slot is positioned along the entire length of said elongated hollow member and whereby said slot creates an opening all the way from the outside to the inside of said elongated hollow member, and whereby recessed member extends from the elongated hollow member and whereby said recessed member is recessed away from the top of the slot forming material at a smaller height below the slot.

2. The claim of 1 whereby there are a plurality of said elongated hollow members and a plurality of said recessed members, whereby there is a plurality of alternating patterns of the elongated hollow members attached to the recessed members attached to another said elongated hollow member and then attached to another said recessed member forming several alternating combination patterns of both features.

3. The claim of 1 wherein said recessed member is attached at the end of said elongated hollow member and said recessed member is attached to said disposable hand tool components comprising of paint brush heads, paint roller covers, dusting feathers, dusting cloths, cleaning cloths, chemical wipes and sandpaper.

4. The claim of 1 wherein there is a left recessed member at the left end of said elongated hollow member and a right recessed member at the right end of said elongated hollow member wherein said left recessed member at the left of said elongated hollow member has a brush head attached and said right recessed member at the right end of said elongated hollow member has a roller cover attached.

5. The claim of 1 wherein there is a left recessed member at the left end of said elongated hollow member and a right recessed member at the right end of said elongated hollow member, wherein said disposable hand tool components comprising of paint brush heads, paint roller covers, dusting feathers, dusting cloths, cleaning cloths, chemical wipes and sandpaper are attached to said left recessed member and attached to said right recessed member.

6. The claim of 1 wherein said elongated hollow member has an inner diameter female shape cross section comprising of a C-shape, D-shape, Oval shape, Square shape, Triangular shape or Polygon shape to prevent said applicator component retainer from rotating when surrounding around said applicator hand tool shaft that also has a mating coupling male shaft outer diameter shape cross section which comprises a C-shaped, D-shaped, Oval shaped, Square shaped, Triangular shaped and Polygon shaped shaft outer diameter shape cross section.

7. The claim of 1 wherein there is a left recessed member at the left end of said elongated hollow member and a right recessed member at the right end of said elongated hollow member wherein there is a 90 degree disk perpendicularly attached to said left recessed member and said right recessed member is attached to said disposable hand tool components comprising of paint brush heads, paint roller covers, dusting feathers, dusting cloths, cleaning cloths, chemical wipes and sandpaper.

8. The claim of 1 wherein there is a left recessed member at the left end of said elongated hollow member and a right recessed member at the right end of said elongated hollow member wherein said left recessed member is attached to a 90 degree disk, whereby said 90 degree disk has an 180 degree panel extending to the left of the 90 degree disk and a wedged shaped foam material that surrounds and is joined to said 180 degree panel with the point of the wedge extending away from the 90 degree disk, and said right recessed member is attached to a 90 degree hollow disk with at least one leg extending to the right of said 90 degree hollow disk with a wedge shaped retainer at the end of said leg and at least one ring attaching the legs when there are two of the legs present.

9. The claim of 1 wherein there is a left recessed member at the left end of said elongated hollow member and a right recessed member at the right end of said elongated hollow member wherein said left recessed member is attached to a 90 degree disk, whereby said 90 degree disk has an 180 degree panel extending to the left of the 90 degree disk and a wedged shaped foam material that surrounds and is joined to said 180 degree panel with the point of the wedge extending away from the 90 degree disk, and said right recessed member has a 90 degree hollow disk extending from the right side of said right recessed member, said 90 degree hollow disk has a hollow plastic tube extending from the right of said 90 degree hollow disk, said elongated hollow member has a D-shaped inner diameter.

10. The claim of 1 wherein there is a left recessed member at the left end of said elongated hollow member and a right recessed member at the right end of said elongated hollow member wherein said left recessed member is attached to a 90 degree disk and said right recessed member is attached to a 90 degree hollow disk with at least one leg extending to the right of said 90 degree hollow disk with a wedge shaped retainer at the end of said leg and at least one ring attaching the legs when there are two of the legs present.

11. The claim of 1 wherein there is a left recessed member at the left end of said elongated hollow member and a right recessed member at the right end of said elongated hollow member wherein said left recessed member is attached to a 90 degree disk and said right recessed member is attached to an attachment tube with a lager diameter than said elongated hollow member.

12. The claim of 1 wherein there is a left recessed member at the left end of said elongated hollow member and a right recessed member at the right end of said elongated hollow member wherein said left recessed member is attached to a 90 degree disk and said right recessed member is attached to an attachment tube with a lager diameter than said elongated hollow member, said attachment tube has at least one leg extending to the right of said the attachment tube with a wedge shaped retainer at the end of said leg.

13. The claim of 1 wherein there is a left recessed member at the left end of said elongated hollow member and a right recessed member at the right end of said elongated hollow member wherein said left recessed member is attached to a 90 degree disk and said right recessed member is attached to an attachment tube with a lager diameter than said elongated hollow member, attached to the right side of said attachment tube is a second left recessed member at the left end of second elongated hollow member and a second right recessed member at the right end of said second elongated hollow member wherein said second right recessed member is attached to a second attachment tube with a larger diameter than said elongated member and said second elongated member but the same diameter as said attachment tube.

14. I claim an applicator hand tool component frame retainer for quickly detaching and quickly attaching disposable hand tool components comprising of paint brush heads, paint roller covers, dusting feathers, dusting cloths, cleaning cloths, chemical wipes and sandpaper onto an applicator hand tool shaft,
said applicator hand tool component frame retainer comprises:
an elongated hollow member, a slot along the length of said elongated hollow member and a left recessed member at the left end of said elongated hollow member and a right recessed member at the right end of the elongated hollow member, an elongated hollow member outer diameter, and an elongated hollow member inner diameter with a D-shaped cross section wherein said left recessed member is attached to a 90 degree disk and said 90 degree disk has an 180 degree horizontal panel extending to the left of the 90 degree disk and said right recessed member is attached to a hollow 90 degree disk and two legs extends to the right of said hollow 90 degree disk with a wedge shaped retainer at the right end of said two legs with at least one circular ring attached to the two legs wherein said circular ring is located in at least one position along the length of the two legs.

15. The claim of 14 wherein said two legs are parallel in nature to each other and are separated but combine to form the shape of a hollow member having an outer diameter and inner diameter whereby said outer diameter of the two legs supports the inner diameter of a roller cover tubular core around the two legs and said inner diameter of the two legs supports around an applicator shaft inside of the two legs.

16. The claim of 14 wherein said 180 degree horizontal panel has at least one thru hole in said 180 degree horizontal panel.

17. The claim of 14 wherein said 180 degree horizontal panel is made as a thin wafer to allow its shape to be maintained as well as to allow flexibility to bend −45 to 45 degrees when a wedged shape foam material is glued to and surrounds said 180 degree horizontal panel.

18. I claim an 180 degree shaped combined mini wedge shaped head and mini roller cover disposable component for quickly attaching and detaching onto and around an applicator hand tool shaft, said 180 degree shaped combined mini wedge shaped head and mini roller cover disposable component comprises of an elongated hollow member, an elongated D-shaped cross sectional inner diameter of said elongated hollow member, a slot along the length of said elongated hollow member that provides a spring force around said applicator hand tool shaft as said slot increases in width as said applicator hand tool shaft is inserted inside of said elongated D-shaped cross sectional inner diameter of said elongated hollow member, a left recessed member at the left end of the elongated hollow member and a right recessed member at the right end of the elongated hollow member, wherein said left recessed member is attached to a 90 degree disk, said 90 degree disk has a 180 degree panel extending to the left of the 90 degree disk and a mini wedged shaped material that surrounds and is glued to said 180 degree panel with a pointed shape of said mini wedge shaped material extending away from the 90 degree disk, and said right recessed member is attached to a 90 degree hollow disk with two legs extending to the right of said 90 degree hollow disk with a wedge shaped retainer at the end of said two legs to retain a mini roller cover and allow said mini roller cover to slip around the two legs and rotate around the two legs while being contained, said two legs having at least one ring attached to the legs, having said ring located in at least one position along the length of the legs to allow the legs to maintain a parallel position so that said wedge shaped retainers and the legs will be held apart allowing said mini roller cover to freely rotate while also being retained until the operator forces said wedge shaped retainers and the legs to come together enough to remove said mini roller cover, said elongated hollow member having the D-shaped inner diameter to prevent said 180 degree shaped combined mini wedge shaped head and mini roller cover disposable component from rotating around said applicator hand tool shaft outer diameter by inserting the D-shaped shaft outer diameter of said applicator hand tool shaft inside of the D-shaped inner diameter of said elongated member thereby creating a coupling attachment for quickly attaching and detaching said 180 degree shaped combined mini wedge shaped head and mini roller cover disposable component from said applicator hand tool shaft.

19. The claim of 18 whereby said 180 degree shaped combined mini wedge shaped head and mini roller cover disposable component has a mini wedge shaped head and a mini roller cover with disposable component material attached comprising of foam paint brush heads, foam paint roller covers, dusting feathers, dusting cloths, cleaning cloths, chemical wipes and sandpaper material.

20. The clam of 18 whereby said 180 degree shaped combined mini wedge shaped head and mini roller cover disposable component has a frame with a mini wedge shaped head and a mini roller cover with disposable component material attached to said frame comprising of foam paint brush heads, foam paint roller covers, dusting feathers, dusting cloths, cleaning cloths, chemical wipes and sandpaper material and said frame has either permanently or non-permanently attached said disposable component material and said non-permanently attached said disposable component material is allowed to attach and detach from said frame using different combination of said disposable component material to attach for use and detach and dispose of after use and to reattach the new disposable component material for a new or a different application.
